(19) United States
(12) Patent Application Publication
(10) Pub. No.: US 2006/0177803 A1
(43) Pub. Date: Aug. 10, 2006

(54) System and method for training distribution management

(75) Inventors: David Vincent Pennington, Kenmore, WA (US); Edward Bermudez Ovalles, Seattle, WA (US); Robin Lee Thompson, Seattle, WA (US)

Correspondence Address: BLACK LOWE & GRAHAM, PLLC, 701 FIFTH AVENUE, SUITE 4800, SEATTLE, WA, 98104, US

(73) Assignee: Envision Telephony, Inc.

(21) Appl. No.: 11/056,531

(22) Filed: Feb. 10, 2005

(51) Int. Cl. G09B 19/00

(52) U.S. Cl. 434/219

(57) ABSTRACT

The present invention provides an improved system and method for training distribution management between a system server and an agent associated with a computer-based system agent. The method includes determining training appropriate for the agent, storing training material associated with the training at the system server and polling the system agent to determine whether the system agent is in communication with the system server. If the system agent is in communication with the system server, a determination is made whether a training opportunity is present. If a training opportunity is present, the agent is notified that training is available. A determination is made whether the agent is willing to accept training. If the agent is willing to accept training, the training material is provided to the agent via the system agent. The invention facilitates improved training necessary to develop and coach agents to provide superior customer service.

### PRIORITY CLAIM

This application claims priority to U.S. Provisional Application No. 60/543,226, filed Feb. 10, 2004, which application is hereby incorporated by reference in its entirety as if fully set forth herein.

### FIELD OF THE INVENTION

This invention relates generally to training systems and, more specifically, to an improved system and method for providing contact center supervisors with the training, quality monitoring and evaluation tools necessary to develop and coach agents to provide superior customer service.

### BACKGROUND OF THE INVENTION

In a traditional setting, agents are trained in groups. In this setting, groups of agents leave their workstations to receive training at a specified time and place. Accordingly, supervisors are forced to wait until a group need arises for a specific subject in order to justify taking groups of agents away from their duties. This lag time means that skill levels are less than optimal during the interim period of time as timely training produces higher retention rates for information and faster learning.

More recent technology has provided the ability to author software-based and audio/video training materials to make it easier for supervisors to coach agents, independently and in a cost effective manner, as well as to customize the content of the training to an individual's or group's specific needs. Using these methods of training, content is delivered directly to agents' desktops, and they can review it as many times as they need at their convenience and timetable. This in turn provides several advantages. For example, new hires have reduced ramp-up times and get operational more quickly, agents can be trained every day without an adverse affect on productivity and training can be extended beyond new-hire training for centers that do not have the luxury of ongoing agent training programs.

While software-based and audio/video training provides superior advantages over traditional training methods, its effectiveness is ultimately a function of whether the agents schedule time for and actually participate in the training. Currently, a coaching supervisor would need to notice on their own when an agent is available for training and then provide the training at an appropriate time. Even then, the agent may or may not participate in the training or let the coaching supervisor know when the training occurred.

Accordingly, there is a need for an improved training system that facilitates timely scheduling and provision of training to agents, monitors agent participation in the training and reports training success once training has been initiated.

### SUMMARY OF THE INVENTION

A preferred embodiment of the present invention provides a method for training distribution management between a system server and an agent associated with a computer-based system agent. The method includes determining training appropriate for the agent, storing training material associated with the training at the system server and polling the system agent to determine whether the system agent is in communication with the system server. If the system agent is in communication with the system server, a determination is made whether a training opportunity is present. If a training opportunity is present, the agent is notified that training is available. A determination is made whether the agent is willing to accept training. If the agent is willing to accept training, the training material is provided to the agent via the system agent.

In accordance with further aspects of the invention, a determination is made whether a predetermined time limit for training has been reached. If the predetermined time limit has been reached, the training material associated with the training is recalled from the system agent.

In accordance with others aspects of the invention, a trainer associated with the system server is notified once the training material has been accepted by the agent.

As will be readily appreciated from the foregoing summary, the invention provides an improved system and method for providing training necessary to develop and coach agents to provide superior customer service.

### BRIEF DESCRIPTION OF THE DRAWINGS

Preferred and alternative embodiments of the present invention are described in detail below with reference to the following drawings.

FIG. 1 is an overview system chart of the preferred embodiment of the present invention.

FIG. 2 is a flowchart of the training material provision methodology in accordance with the preferred embodiment of the present invention.

FIG. 3 is a flowchart of a training material provision methodology in accordance with an alternative embodiment of the present invention.

### DETAILED DESCRIPTION OF THE PREFERRED EMBODIMENT

The present invention is directed towards an improved system and method for providing contact center supervisors with the training, quality monitoring and evaluation tools necessary to develop and coach agents to provide superior customer service. The present invention is described in the context of a customer service program, and references supervisors or trainers and agents who engage in providing customer service in one of a variety of different industries. The improvements of the present system and method are, however, equally applicable to a variety of different types of training programs.

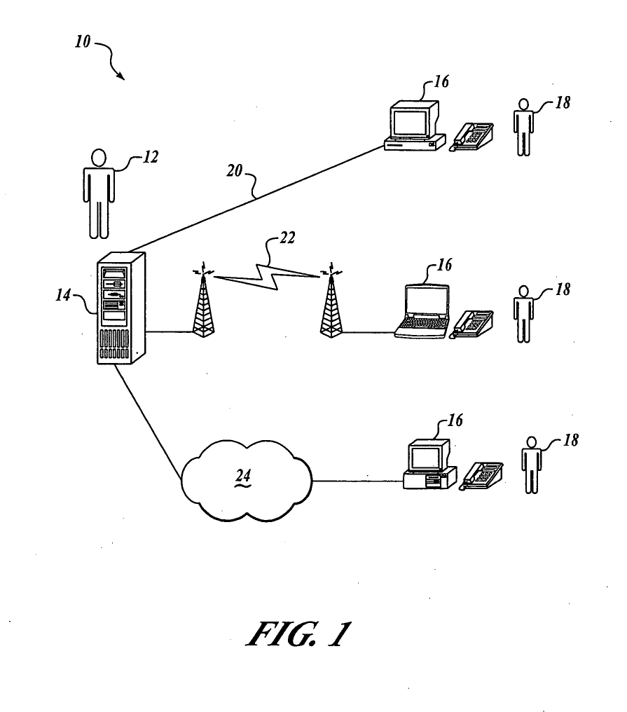

More specifically, the preferred embodiment of the present invention is an improved training system and method that facilitates timely scheduling and provision of training to agents, monitors agent participation in the training and reports training success once training has been initiated. By way of overview, with reference to FIG. 1, the preferred improved training system 10 includes a trainer 12, a system server 14 including storage and processing capability, one or more system agents 16 in communication with the system server 14, each system agent preferable having storage and processing capability, a telephone connection and a user interface, and one or more agents 18 associated with each system agent.

The trainer 12 may be a supervisor or other designated person responsible for overseeing the customer service provided by the agents 18. Alternatively, the trainer 12 may be an automated system component configured to monitor performance and status of customer service agents, suggest appropriate training for the agents based on a set of predetermined criteria (e.g., historical performance, prior training, years of experience, etc.), and provide automated interface and reporting between the server, agent and other systems or persons outside the invention. The user interface of the system agents 16 is used to provide interaction between the system agents 16 and agents 18 where each agent is a person involved in providing customer support. Alternatively, the system agent may be an automated component that provides customer service via voice or data without direct reliance on other systems or persons outside the invention. In this embodiment, the agents 18 would not be part of the system. Communication between the system server 14 and the system agents 16 may occur in a number of different ways, for example, via a wired connection 20, a wireless connection 22 (e.g., Bluetooth) or an intranet or the Internet 24.

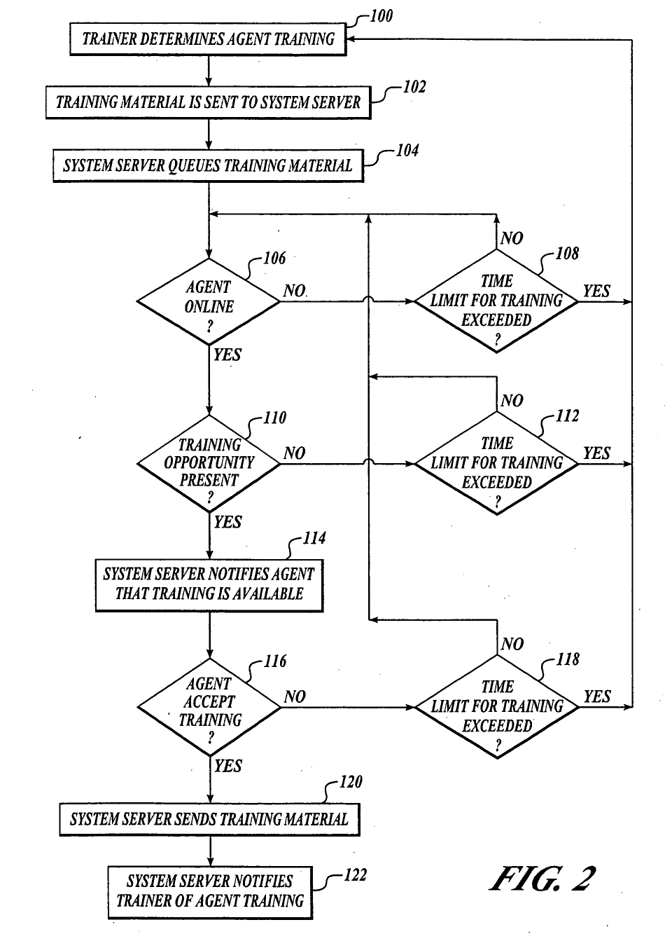

The system and method of the present invention is more particularly described with further reference to FIG. 2. At block 100, a trainer 12 determines that an agent 18 is in need of particular training. At block 102, training material is sent to a system server 14. Training material refers to any type of instructional information used to educate, inform or otherwise teach an agent in proper procedure, technique or other desirable traits in the handling of customer service or any other type of business or personal interaction. Training material may be created by supervisors, trainers or any other person or organization assigned to develop such material. Training material may include one or more different types of training media. For example, training material may include a text, audio or video segment, software presentation, or any combination thereof. At block 104, the system server queues the training material pending review of the status of the agent 18 and communication of the training material to the agent. In an alternative embodiment, the training material may originally be stored at the system server 14, thereby eliminating steps 102 and 104. In yet an alternative embodiment, the training material may be stored at a location different from but accessible by the system server 14 or a system agent 16.

At decision block 106, a determination is made whether an agent 18 is online at the system agent 16 or, in other words, logged onto the system agent 16 and in communication with the system server 14, and therefore a potential candidate for training. This determination is preferably made by the system server 14 polling or, in other words, requesting status information from the system agent 16 via the communication connection (e.g., 20, 22 or 24). If the agent 18 is not online, the logic proceeds to decision block 108, where a determination is made whether the time limit allowed for the agent 18 to perform the training has been exceeded. The time limit may be a predetermined time interval set by the trainer or other system administrator or a dynamically adjustable time limit based on competing demands for the training material (e.g., if the training material is unique or subject to limited access). If the time limit for training has been exceeded, the logic returns to block 100 for a subsequent determination as to the training needed for a particular agent. If the time limit for training has not been exceeded, the logic returns to decision block 106. If, at decision block 106, a determination is made that the agent 18 is online at the system agent 16 or, in other words, logged onto the system agent 16, and therefore a potential candidate for training, the logic proceeds to decision block 110.

At decision block 110, a determination is made whether a training opportunity is present. This inquiry is preferably separate from the determination of whether the agent is online, and may involve several independent inquires. For example, a determination may be made as to whether the agent 18 is available for training, whether the training material is still available and whether the resources exist to conduct the agent training at that time. A nonexclusive list of considerations in determining whether a training opportunity is present includes:
Is the agent busy? For example, the agent may be occupied providing customer service on the telephone or via real-time messaging.
Has the agent already performed the training?
Has a predetermined time limit in which the agent may perform the training been reached?
Has the agent been previously notified of the training opportunity and ignored the training or otherwise failed to initiate the training?
If the training involves the use of finite system resources (e.g., audio or video channels), are such resources available to provide the training?

In the preferred embodiment, at decision block 110, a determination is made whether the agent 18 is deemed “idle.” An agent is deemed idle when the agent is online and “on-hook” or, in other words, not providing customer service, for the predetermined time. This predetermined time is preferably based on an idle threshold setting determined by the trainer 12. In other words, in this embodiment, when an agent is online and has not been involved in providing customer services (e.g., telephone or messaging support) for a predetermined period of time, the agent is considered “idle” and a prime candidate for training. This does not mean that the agent will immediately receive delivery of the training material. This is because the system server 14 may be currently distributing training material to other “idle” agents, or there may be other basis for delay, for example, due to limitation on system resources.

A preferred methodology for determining whether an agent 18 is deemed “idle” at decision block 110 follows. The agent 18 is detected to be online at the system agent 16 by the following conditions:

(a) A login event has been detected from system agent; or

(b) At least one phone call is made on the system agent; and

(c) The system server 14 has detected one of the two events.

At that point, the system server 14 begins polling the system agent 16 at periodic intervals to determine whether an idle time event is generated. An idle time event is generated when the system settings threshold (e.g., in seconds) has elapsed from the time a customer service phone call is concluded (e.g., hang-up). In other words, the idle time condition is met after a predetermined time period has elapsed since the agent concluded a customer service call.

If the training opportunity is not present at decision block 110, the logic proceeds to decision block 112, where a determination is made whether the time limit allowed for the agent 18 to perform the training has been exceeded. The time limit may be a predetermined time interval set by the trainer or other system administrator or a dynamically adjustable time limit based on competing demands for the training material (e.g., if it is unique or subject to limited access). If the time limit for training has been exceeded, the logic returns to block 100 for a subsequent determination as to the training needed for a particular agent. If the time limit for training has not been exceeded, the logic preferably returns to decision block 106, where it determines at a subsequent interval whether the agent 18 is online before determining whether a new training opportunity is present. If, at decision block 110, a determination is made that a training opportunity is present, the logic proceeds to block 114.

At block 114, the system server 14 generates a system alert notifying the agent 18 that the training material is available and that training may be initiated. This alert may take several different forms, including for example a text, audio or video email, instant message, pop-up notice or telephone call communicated via the system agent 16. The logic then proceeds to decision block 116.

At decision block 116, a determination is made whether the agent 18 accepts the training. Despite meeting other conditions for training, including being online and having a training opportunity present, the agent 18 may decline to participate in training. If the agent does not accept training at decision block 116, the logic proceeds to decision block 118, where a determination is made whether the time limit allowed for the agent 18 to perform the training has been exceeded. The time limit may be a predetermined time interval set by the trainer or other system administrator or a dynamically adjustable time limit based on competing demands for the training material (e.g., if it is unique or subject to limited access). If the time limit for training has been exceeded, the logic proceeds to block 100 for a subsequent determination as to the training needed for a particular agent. If the time limit for training has not been exceeded, the logic preferably returns to decision block 106, where it determines at a subsequent interval whether the agent 18 is online before determining whether a new training opportunity is present. If, at decision block 116, a determination is made that the agent accepts training, the logic proceeds to block 120.

In a preferred embodiment, at block 120, once the alert has been generated and the agent accepts the training, the training material will be will be sent from the system server 14 to the agent 18 via the system agent 16. Depending on the medium of the training material, this may be as an email attachment, telephone call or other transmission. In an alternative embodiment, the agent 18 may retrieve the training material from the system server 14 directly or from a different predesignated storage location. The logic then continued to block 122. At block 122, once the system server has sent the training material to the agent, the system server notifies the trainer that the training material has been accepted.

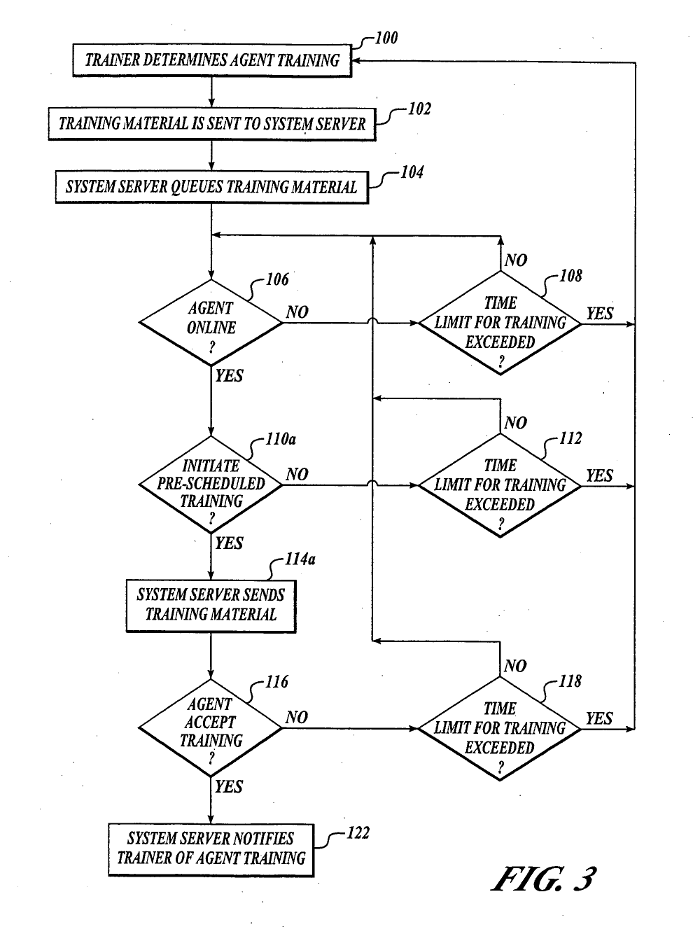

In an alternative embodiment of the present invention, blocks 110 through 114 may be condensed or eliminated in order to provide the agent with training material at preassigned times rather then upon determination that a training opportunity is present. As shown with reference to FIG. 3, in this alternative embodiment, at block 110a a determination is made whether it is time to initiate pre-scheduled agent training. If answered in the affirmative, the logic would proceed to block 114a, where the system server 14 sends training material to the agent 18 via the system agent 16. The logic then proceeds to decision block 116 as described above. If, at decision block 116, the agent accepts the training that has been sent to the agent, training may commence and the logic proceeds to block 122, where the system server notifies the trainer that the training material has been provided to the agent.

While the preferred embodiment of the invention has been illustrated and described, as noted above, many changes can be made without departing from the spirit and scope of the invention. For example, with reference to FIG. 2, at blocks 108, 112 and 118, there may be alternative bases for returning the training material. For example, in addition to exceeding a time limit, the training materials may be returned if requested by the trainer, or another agent has a higher priority for the training material and it is a finite resource. In addition, in an alternative embodiment, the logic path for decision blocks for 112 and 118 may be changed. For example, a negative determination at block 112 may return the logic directly to decision block 110 to determine if a training opportunity is present. This variation may be appropriate, for example, if it the agent was to be online for a known period of time. Likewise, a negative determination at block 118 may return the logic directly to decision block 116 to determine if the agent accepts the training. This variation may be appropriate, for example, to give the agent multiple opportunities to accept the training invitation. Accordingly, the scope of the invention is not limited by the disclosure of the preferred embodiment. Instead, the invention should be determined entirely by reference to the claims that follow.

The embodiments of the invention in which an exclusive property or privilege is claimed: are defined as follows:

1. A method for training distribution management between a system server and an agent associated with a computer-based system agent, comprising:
determining training appropriate for the agent;
polling the system agent to determine whether the system agent is in communication with the system server;
if the system agent is in communication with the system server, determining whether a training opportunity is present;
if a training opportunity is present, notifying the agent that training is available;
ascertaining whether the agent is willing to accept training; and
if the agent is willing to accept training, providing the training material associated with the training at the system agent.

2. The method of claim 1, further comprising storing training material associated with the training at the system server.

3. The method of claim 1, further comprising:
determining whether a predetermined time limit for training has been reached;
if the predetermined time limit has been reached, recalling the training material associated with the training from the system agent.

4. The method of claim 1, wherein determining whether a training opportunity is present comprises at least one of determining whether the agent is busy, determining whether the agent has previously completed the training, determining whether a predetermined time limit in which the agent may perform the training has been reached, determining whether the agent has previously declined training and determining whether resources necessary to provide the training are available.

5. The method of claim 1, further comprising notifying a trainer associated with the system server that the training material has been accepted by the agent.

6. A system for training distribution management for providing training to an agent, comprising:
a polling component for determining whether a system agent associated with the agent is in communication with the system server;
a training component for determining whether a training opportunity is present;
an alert component for notifying the agent that training is available;
a decision component for ascertaining whether the agent is willing to accept training; and
a provisioning component for providing the training material associated with the training at the system agent.

7. The system of claim 6, further comprising a storage component for storing training material associated with the training in communication with a system server;

8. The system of claim 6, further comprising:
a timing component for determining whether a predetermined time limit for training has been reached; and
a recall component for recalling the training material associated with the training from the system agent.

9. The system of claim 6, wherein the training component determines whether a training opportunity is present by evaluating at least one of the following factors: whether the agent is busy, whether the agent has previously completed the training, whether a predetermined time limit in which the agent may perform the training has been reached, whether the agent has previously declined training and whether resources necessary to provide the training are available.

10. The system of claim 6, further comprising a reporting component for notifying a trainer associated with the system server that the training material has been accepted by the agent.

11. A method for training distribution management between a system server and an agent associated with a computer-based system agent, comprising:
determining training appropriate for the agent;
polling the system agent to determine whether the system agent is in communication with the system server;
if the system agent is in communication with the system server, determining whether it is time to initiate pre-scheduled training;
if it is time to initiate pre-scheduled training, providing the training material associated with the training at the system agent;

12. The method of claim 11, further comprising storing training material associated with the training at the system server.

13. The method of claim 11, further comprising:
if it is time to initiate pre-scheduled training, notifying the agent that training is available;
ascertaining whether the agent is willing to accept training; and
if the agent is willing to accept training, providing the training material associated with the training at the system agent.

14. The method of claim 11, further comprising:
determining whether a predetermined time limit for training has been reached;
if the predetermined time limit has been reached, recalling the training material associated with the training from the system agent.

15. The method of claim 11, further comprising notifying a trainer associated with the system server that the training material has been provided to the agent.
